(19) United States
(12) Patent Application Publication
(10) Pub. No.: US 2024/0213182 A1
(43) Pub. Date: Jun. 27, 2024

(54) PHYSICAL UNCLONABLE FUNCTIONS WITH SILICON-RICH DIELECTRIC DEVICES

(71) Applicant: Michael Kozicki, Phoenix, AZ (US)

(72) Inventor: Michael Kozicki, Phoenix, AZ (US)

(21) Appl. No.: 18/431,219

(22) Filed: Feb. 2, 2024

Related U.S. Application Data
(62) Division of application No. 17/112,668, filed on Dec. 4, 2020, now Pat. No. 11,935,843.
(60) Provisional application No. 62/945,683, filed on Dec. 9, 2019.

(51) Int. Cl. H01L 23/00; H01L 23/482; H04L 9/32

(52) U.S. Cl. CPC H01L 23/573; H01L 23/482; H04L 9/3278

(57) ABSTRACT

Systems for physical unclonable function (“PUF”) generation, PUF devices, and methods for manufacturing PUF devices. In one implementation, the system includes a plurality of PUF devices and an electronic controller. Each of the plurality of PUF devices include a first electrochemically-inactive electrode, a second electrochemically-inactive electrode, and a layer of silicon suboxide. The layer of silicon suboxide is positioned directly between the first electrochemically-inactive electrode and the second electrochemically-inactive electrode. The electronic controller is communicably coupled to the plurality of PUF devices. The electronic controller is configured to read binary values associated with the plurality of PUF devices.

### CROSS-REFERENCE TO RELATED APPLICATIONS

This application is a non-provisional of and claims benefit of U.S. Provisional Application No. 62/945,683, filed on Dec. 9, 2019, the entire contents of which are incorporated herein by reference.

### STATEMENT REGARDING FEDERALLY SPONSORED RESEARCH OR DEVELOPMENT

This invention was made with government support under 1827753 awarded by the National Science Foundation. The government has certain rights in the invention.

### BACKGROUND

Internet security has become increasingly important, in part because of the rapidly growing internet of things (“IoT”). Many IoT devices communicate on open networks with little or no security, making them vulnerable to network intrusion including, for example, distributed denial of service (“DDOS”) attacks. Most IoT devices, however, are based on low-power system on a chip (“SOC”) designs. Thus, full security on these IoT devices is preferably implemented with as little circuit overhead or additional power consumption as possible to meet operational requirements.

Current secure communications require random number generation to create a secure key. The security of the key is directly related to the randomness of the number generation. Various software approaches have been used to generate pseudo-random binary sequences (“PRBS”), but these can be cracked with sufficient computing power. Alternatively, naturally occurring randomness in semiconductor device characteristics can provide random number generation via appropriate reading circuitry from within an integrated circuit, for example, with the generated number being unique to each circuit. This has been demonstrated with static random access memory (“SRAM”) and resistive random access memory (“RRAM”). Arrays of these type of memories have been used as generators of Physical Unclonable Functions (“PUFs”).

In securing IoT devices with integrated hardware, it is important that the technology operates at very low-energy to preserve the often-limited power sources used and to prevent side-channel attacks by, for example, a differential power analysis which extracts security information from patterns of power usage by the circuitry. It is also important that the additional circuitry does not add significant cost to the protected component, as edge devices are often deployed in large numbers and higher individual device costs will lead to much larger overall system cost. To achieve the above-noted important requirements, PUF technology should be able to be easily integrated with CMOS logic, using existing materials and processes with few additional masking layers.

### SUMMARY

The present disclosure provides silicon suboxide (“SiOₓ”) structures and methods of creating silicon suboxide structures for dielectric devices. The security of the Internet of Things (“IoT”) is questionable and is exceptionally vulnerable to denial of service-based attacks. To secure the IoT, a method of producing physical tags that serve as unique identifiers and keys is needed. This technology provides a method of stochastically creating these keys with SiOₓ. Unlike previous technologies, this technology does not require transition metals to function, and the properties of the SiOₓ structures can be controlled by modulating thickness, area, and oxidation.

For example, the present disclosure provides a system for physical unclonable function (“PUF”) generation. In one implementation, the system includes a plurality of PUF devices and an electronic controller. Each of the plurality of PUF devices include a first electrochemically-inactive electrode, a second electrochemically-inactive electrode, and a layer of silicon suboxide. The layer of silicon suboxide is positioned directly between the first electrochemically-inactive electrode and the second electrochemically-inactive electrode. The electronic controller is communicably coupled to the plurality of PUF devices. The electronic controller is configured to read binary values associated with the plurality of PUF devices.

The present disclosure also provides a physical unclonable function (“PUF”) device. In one implementation, the PUF includes a first electrochemically-inactive electrode, a second electrochemically-inactive electrode, and a layer of silicon suboxide. The layer of silicon suboxide is positioned directly between the first electrochemically-inactive electrode and the second electrochemically-inactive electrode.

The present disclosure further provides a method for manufacturing a physical unclonable function (“PUF”) device. The method includes depositing a first electrochemically-inactive electrode. The method also includes depositing a layer of silicon suboxide onto the first electrochemically-inactive electrode. The method further includes depositing a second electrochemically-inactive electrode onto the layer of silicon suboxide such that the layer of silicon suboxide is positioned directly between the first electrochemically-inactive electrode and the second electrochemically-inactive electrode.

The PUF devices disclosed herein exhibit stochastic behavior from device-to-device that is not dependent on process variations but is instead due to the entropy of the material formation process and the resulting atomic structure of the materials. In addition, the PUF devices disclosed herein exhibit stable characteristics over time at reasonable operating temperatures (e.g., up to 125° C.). Further, the PUF devices disclosed herein operate at low voltage (e.g., 1 volt) and current (e.g., 100 nanoamps). In addition, the PUF devices disclosed herein are compatible with standard CMOS processing and equipment.

Other aspects of the invention will become apparent by consideration of the detailed description and accompanying drawings.

### BRIEF DESCRIPTION OF THE DRAWINGS

FIG. 1A is graph of an example of a distribution of a set voltage for a memory array with contiguous 0 and 1 ranges.

FIG. 1B is graph of an example of a distribution of a set voltage for a memory array with 0 and 1 ranges separated by a third state.

FIG. 2 is a block diagram of one example of a PUF device in accordance with some implementations of the present disclosure.

FIG. 3 is a graph of examples of tunneling current density for various oxide layers as a function of applied voltage.

FIG. 4A is a first top view of an example of a crossbar array of PUF devices in accordance with some implementations of the present disclosure.

FIG. 4B is a second top view of the crossbar array of FIG. 4A.

FIG. 4C is a cross-section view of a PUF device included in the crossbar array of FIG. 4A in accordance with some implementations of the present disclosure.

FIG. 5 is a block diagram of an example of a system for PUF generation in accordance with some implementations of the present disclosure.

FIG. 6 is a flow diagram of an example of a method for manufacturing a PUF device in accordance with some implementations of the present disclosure.

FIG. 7 is a graph of examples of current vs. voltage plots for various diameter PUF devices with 5 nanometer thick SiOₓ.

FIG. 8 is a graph of an example of normal distributions of measured currents for eight PUF devices in a crossbar array.

FIG. 9 is a graph of an example of normal distributions of measured currents for ten PUF devices in a crossbar array.

FIG. 10 is three-dimensional model of an example of an iso-surface plot for a DFT simulation of SiOₓ where x is 1.3.

### DETAILED DESCRIPTION

Before any implementations of the present disclosure are explained in detail, it is to be understood that the present disclosure is not limited in its application to the details of construction and the arrangement of components set forth in the following description or illustrated in the following drawings. The invention is capable of other implementations and of being practiced or of being carried out in various ways.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising”, “consisting of”, and “consisting essentially of”, the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4”. The term “about” may refer to plus or minus 10% of the indicated number. For example, “about 10%” may indicate a range of 9% to 11%, and “about 1%” may mean from 0.9-1.1. Other meanings of “about” may be apparent from the context, such as rounding off, so, for example “about 1” may also mean from 0.5 to 1.4.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrase “at least one of A, B, . . . and N” or “at least one of A, B, . . . N, or combinations thereof” are defined in the broadest sense to mean one or more elements selected from the group comprising A, B, . . . and N, that is to say, any combination of one or more elements A, B, . . . or N including any one element alone or in combination with one or more of the other elements, which may also include, in combination, additional elements not listed.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

For purposes of this disclosure, the chemical elements are identified in accordance with the Periodic Table of the Elements (CAS version) and the Handbook of Chemistry and Physics (98th Ed., inside cover).

The term “silica,” as used herein unless otherwise defined, means silicon suboxide (“SiOₓ”), where x may range from greater than or equal to 1 to less than or equal to 2. More particularly, the term “silica” may refer to SiOₓ where x equals a single value (within normal experimental tolerance) from 1 to 2, or “silica” may refer to SiOₓ where x is a mixture of values from 1 to 2. Even more particularly, the term “silica” may refer to SiOₓ where x equals about 1.3.

The term “silicon suboxide,” as used herein unless otherwise defined, means SiOₓ, where x may range from greater than 1 to less than 2. More particularly, the term “silicon suboxide” may refer to SiOₓ where x equals a single value (within normal experimental tolerance) between 1 to 2, or “silicon suboxide” may refer to SiOₓ where x is a mixture of values between 1 to 2. Even more particularly, the term “silicon suboxide” may refer to SiOₓ where x equals about 1.3.

A physical unclonable function (“PUF”) can be embodied in a physical structure, such as a memory array, and has the characteristic of being easy to evaluate but hard to predict due to the randomness of the underlying mechanism. For practical security applications, a PUF system should be simple to make but difficult to duplicate, even when the exact manufacturing process that produced it is known. Randomness occurs naturally at the nanoscale in materials that make up memory arrays, which leads to randomly distributed cell characteristics in these devices.

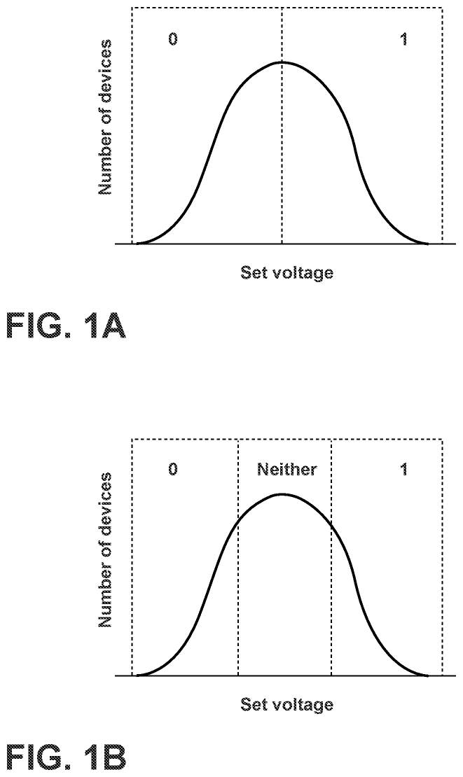

Programmable resistance devices exhibit subtle random differences in operational parameters from cell-to-cell, due to the stochastic nature of the formation of the conducting pathway. For example, the voltage at which the devices transition from a high resistance “off” state to a low resistance “on” state (i.e., the set voltage) varies randomly across an array of devices. This parameter can be partitioned into ranges representing logic 0 and logic 1. For example, FIG. 1A is a one example of a graph that illustrates a voltage range petitioned into a first range below a set voltage that represents logic 0 and a second range above the set voltage that represents logic 1. This parameter can also be partitioned with an intermediate state being defined in an intervening range. For example, FIG. 1B is a one example of a graph that illustrates a voltage range petitioned into a first range that represents logic 0, a second range that represents logic 1, and a third range that represents neither logic 0, nor logic 1. In this approach, the length of a random word is directly proportional to the size of the array.

PUFs can strengthen the authentication methods of Internet of things (“IoT”) elements, because they act as “digital signatures” of the hardware; to support security protocols PUFs can also operate as data-base-free authentication devices, as no secret keys or passwords have to be stored in the IoT; the cost structure of most PUFs is, in general, very low. PUFs exploit intrinsic manufacturing variations introduced during the fabrication of the electronic components of the IoTs. Variations such as critical dimensions, doping levels of semiconducting layers, and threshold voltages make each component unique and identifiable from each other. The PUF's underlying mechanism is the creation of a large number of challenges (i.e., input), responses (i.e., output), and pairs (called CRPs) which are unique to each device. Once deployed during the authentication cycles, PUFs are queried with challenges. The authentication is granted when the rate of correct matching responses is statistically high enough. PUFs can be generated with several components, such as ring oscillators and circuits with gate delays with field-programmable gate array (“FPGA”), static random access memories (“SRAMs”), sensors and microelectromechanical systems (“MEMS”) devices, Flash memories, magnetic memories, and various resistive random access memory (“RAM”) components.

However, PUFs can have (i) a lack of stability of the physical parameters that creates high error rates due to natural drifts or noisy conditions, and (ii) insufficient secret properties of the PUFs that make them vulnerable through side channel analysis by hackers. PUFs based on existing technologies often struggle to deliver in these two areas, and this is because these two limitations are often in conflict with each other: strong PUFs can have low error rates but be too easy to analyze, while weak PUFs can have high error rates and be well protected from side channel analysis.

A PUF system can be based on memory in an array relating to resistive memory devices that use a silicon-rich silicon suboxide layer sandwiched between a copper electrode and an electrochemically-inactive electrode. The silicon-rich suboxide layer allows the copper to be readily incorporated in the dielectric, and thus facilitates the resistance switching effect via the formation and removal of a copper-rich conducting region. Whereas this follows the trend of various RRAM-based PUFs, the inherent plasticity of such devices might not be suitable for all forms of PUF, particularly those which rely on different characteristics from device-to-device but extremely stable characteristics for each individual device. For example, if an array of such elements was used to generate a key by applying a small voltage, (e.g., around 1 volt) to each device and then reading the current, (or applying a small current, e.g., 100 nanoamps, and then reading the voltage), and then using the variations in current (voltage) to generate a digital key as shown in FIGS. 1A and 1B, then this array should return exactly the same key every time it was queried. The motion of the copper in the oxide, especially at elevated temperature over time, would make read-to-read variations on the same device likely, and hence the stability of the key would be adversely affected. Note that the mode of operation described in system type of PUF system, in which each device is “reset” prior to interrogation, would largely mitigate this issue, but this involves additional programming steps which may slow the operation of the system.

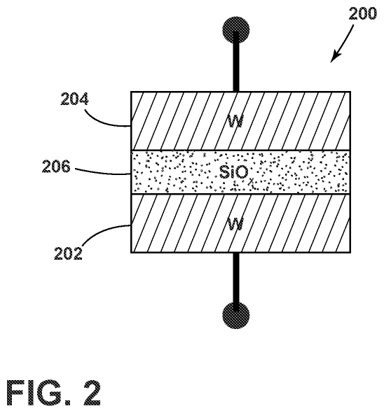

FIG. 2 is a diagram of an example of a PUF device 200. The PUF device 200 has a metal-insulator-metal (“MIM”) stack configuration, which is the most compact and easiest to fabricate, leading to low manufacturing costs. The PUF device 200 includes a first electrode 202, a second electrode 204, and an insulation layer 206. The first electrode 202 and the second electrode 204 include one or more electrochemically-inactive elements that do not supply mobile metal ions into the insulation layer 206. No mobile metals (e.g., copper or silver) are included in the first electrode 202 and the second electrode 204. Further, no mobile metals are included in the insulation layer 206.

The insulation layer 206 illustrated in FIG. 2 includes a layer of silicon suboxide (“SiOₓ”) where the x value ranges from 1 to 2. In some implementations, the x value of the layer of silicon suboxide is between 1.2 and 1.6. In the implementation illustrated in FIG. 2, the first electrode 202 and the second electrode 204 include tungsten (“W”). In other implementations, the first electrode 202 and the second electrode 204 may include different electrochemically-inactive materials. For example, the first electrode 202 and the second electrode 204 may include tungsten (“W”), nickel (“Ni”), platinum (“Pt”), titanium nitride (“TiN”), tantalum nitride (“TaN”), titanium tungsten (“TiW”), or polycrystalline silicon (poly-Si).

In some implementations, the first electrode 202 and the second electrode 204 may be isolated from each other in non-device regions by a relatively thick layer of a dielectric. A variety of dielectric materials may be used for the isolation, such as thick SiO₂, Si₃N₄, or various dielectric polymers, for example. The isolation material may be formed by a variety of methods commonly known in the art.

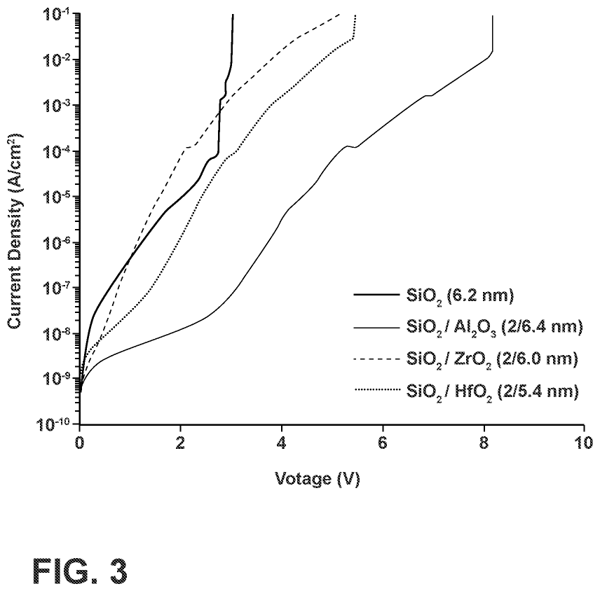

Stoichiometric oxides such as SiO₂, although being relatively easy to form and being completely compatible with CMOS processing, are not a good option for this application due to their extremely high resistivity which significantly limits current flow. For SiO₂, the resistivity is in the order of 10¹⁵ Ω.cm which would result in a current density of 2×10⁻⁹ A/cm² at 2×10⁶ V/cm. In thin layers (e.g., less than 10 nanometers), tunneling current will dominate so that a current density around 10⁻⁶ A/cm² will be attained for the same field (1.2 volts across a 6 nanometer thick film, as shown in FIG. 3).

In some practical applications in which the metal-insulator-metal structure is integrated along with CMOS circuitry, the area of the device may be in the order of 100 μm² (10⁻⁶ cm²) or less, resulting in very small current levels. For example, in a 10 micrometer by 10 micrometer device, 1 picoamp (10-12 A) would flow due to the tunnel current, which is well below the 100 nanoamp (10-7 A) target and is too small to be read accurately with on-chip sensing circuitry. Higher voltage across the film increases the current flow but breakdown occurs before the current density rises to any useful level. Note that the inclusion of other oxide dielectrics allows higher current densities to be attained prior to breakdown (see FIG. 3) but this exceeds the 1 volt operating target and complicates processing.

As disclosed herein, the PUF device uses a non-stoichiometric silicon-rich suboxide SiOₓ, where, for example, 1.2<x<1.6, much like that used in a RRAM design but without the mobile metal component. This material can be deposited by physical vapor deposition (“PVD”—e.g., sputtering, co-sputtering, reactive sputtering) or chemical vapor deposition (“CVD”—e.g., low pressure CVD, plasma-enhanced CVD, remote plasma CVD), using available systems and source materials. Both of the first electrode 202 and the second electrode 204 in the structure can be tungsten, which is commonly used in the back-end-of-line in CMOS processing, or any other common electrochemically-inactive conductor (Pt, Al, TIN, TiW, doped polycrystalline silicon, etc. Thin films (e.g., between 4 nanometers and 8 nanometers) of SiOₓ will allow electron current to flow at relatively low voltage due to the percolation pathways formed by nanoscale silicon-rich zones, characterized by low oxygen concentration, Si—Si bonding, and higher local conductivity. The position of these zones will be random as there is no long-range order in the material and hence current flow/magnitude will be slightly different from device-to-device for a particular applied voltage and this will provide the required stochasticity. The covalent bonding (rather than ionic bonding) in the structure will make it highly rigid, providing the individual device stability required for the PUF approach described above. Note that these devices will be incapable of switching at low voltages (e.g., less than 1 volt) but the approach will still allow Cu—SiOₓ RRAM memory devices to be fabricated on the same IC as the PUF elements by the use of an additional mask that determines the material of one of the electrodes—oxidizable (e.g., Cu) for RRAM devices and non-oxidizable (e.g., W) for the PUF devices. Metal-free SiOₓ devices can exhibit a switching effect at higher voltage (e.g., greater than 1 volt) due the migration of oxygen vacencies which leave silicon filiments that a form conducting bridge between the electrodes.

In some implementations, the thin layer of silicon suboxide may have a thickness of about 1 nanometer to about 10 nanometers, about 2 nanometers to about 9 nanometers, about 3 nanometers to about 8 nanometers, or about 4 nanometers to about 8 nanometers. In some implementations, the thin layer of silicon suboxide may have a thickness of about 1 nanometer, about 2 nanometers, about 3 nanometers, about 4 nanometers, about 5 nanometers, about 6 nanometers, about 7 nanometers, about 8 nanometers, about 9 nanometers, or about 10 nanometers.

A full switching operation may require about 3 volts and about 100 microamps for about 400 microseconds, which gives 300 microwatts and 120 nanojoules for power and energy, respectively. In some implementations, the operating current may be as low as about 10 nanoamps. In other implementations, the operating current may be as low as about 10 picoamps, such as for certain copper-silicon oxide devices.

In certain implementations, PUF generation may utilize lower power and energy because, at least in part, complete switching is not required to generate random numbers (i.e., set voltage can be determined without fully switching a device to a low resistance on state). In certain implementations, using very small currents and voltages which alter the metal concentration in a region between the electrodes, but which does not result in a continuous stable filament results in volatile device operation, which may dispose the need for pre-erase and/or post-erase steps.

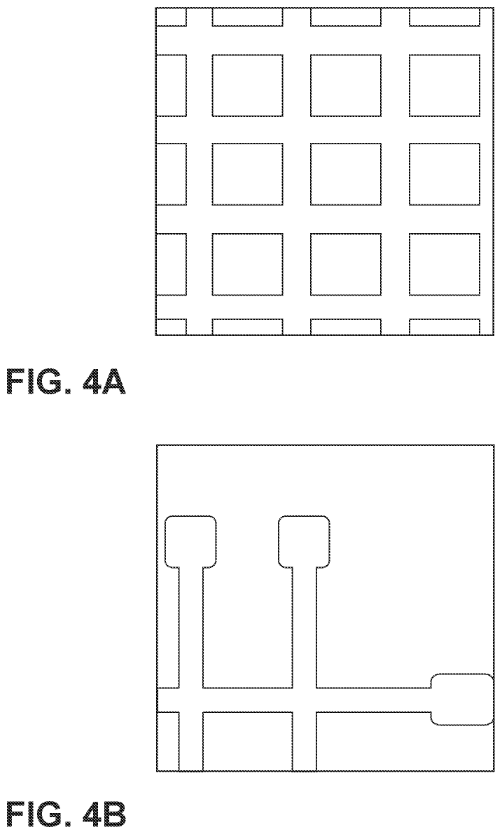

In some implementations, a plurality of PUF devices are arranged in a crossbar array. FIGS. 4A, 4B, and 4C illustrate an example of a crossbar array of PUF devices comprising Ni—SiOₓ—Ni. Crossbar arrays are simple circuits comprising a number of column and row electrodes (32 of each in this case) separated by the SiOₓ material (e.g., 5 nanometer thick, deposited by plasma-enhanced chemical vapor deposition) so that every crossing point is a device—the 32×32 array provides 1,024 devices (=1 Kb). As illustrated in FIG. 4C, the row electrode and the column electrode may be isolated from each other in non-device regions by a relatively thick layer of a dielectric (i.e., Si₃N₄).

The PUF devices are quite large (30 micrometer×30 micrometer active area) but they operate in the “sweet spot” of voltage (less than 1 volt) and current (less than 1 microamp) to avoid side channel attacks by, for example, differential power analysis (“DPA”). The devices and the array can be made more compact but operate at the same current range, by either increasing the voltage slightly or decreasing the SiOₓ thickness in the smaller area devices. In some implementations, a slightly more silicon rich SiOₓ can be used to maintain current flow for the same voltage in smaller devices but there are limits to how far the oxygen content can be decreased.

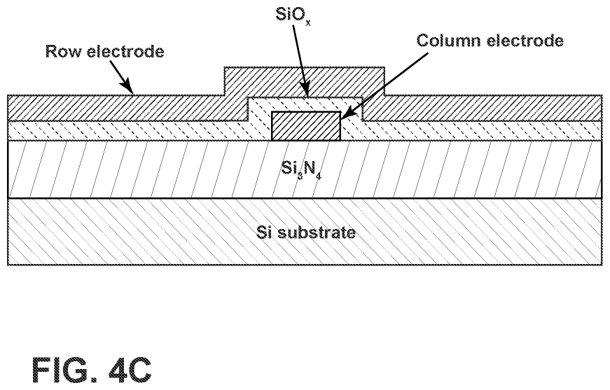

FIG. 5 is a block diagram of one example of a system 500 for PUF generation. The system 500 illustrated in FIG. 5 includes a plurality of PUF devices 502 and an electronic controller 504. While five PUF devices are illustrated in FIG. 5, the system 500 may include more or less than five PUF devices. In some implementations, the plurality of PUF devices 502 are arranged in a crossbar array. In some implementations, the PUF devices 502 illustrated in FIG. 5 are the same as the PUF device 200 illustrated in FIG. 2.

The electronic controller 504 illustrated in FIG. 5 includes an electronic processor 506 (for example, one or more microprocessors, ASICs, SoCs, or other electronic controllers), memory 508, an input/output interface 510, a sensing circuit 512, and a bus 514. The bus 514 connects various components of the electronic controller 504 including, for example, the memory 508 to the electronic processor 506. The memory 508 includes read only memory (“ROM”), random access memory (“RAM”), an electrically erasable programmable read-only memory (“EEPROM”), other non-transitory computer-readable media, or a combination thereof. The electronic processor 506, in one implementation, is configured to retrieve program instructions and data from the memory 508 and execute, among other things, instructions to perform the methods described herein. Alternatively, or in addition to, the memory 508 is included in the electronic processor 506. The input/output interface 510 includes routines for transferring information between components within the electronic controller 504 and components external to the electronic controller 504. The input/output interface 510 is configured to transmit and receive signals via wires, fiber, wirelessly, or a combination thereof. Signals may include, for example, control signals, information, data, serial data, data packets, analog signals, or a combination thereof. The electronic controller 504 is communicably coupled to the PUF devices 502. The sensing circuit 512 is configured to read binary values associated with the PUF devices 502. In some implementations, the sensing circuit 512 applies voltage to all (or any subset) of the PUF devices 502 to read the binary values associated therewith. For example, the sensing circuit 512 may apply a voltage of less than or equal to 1 volt. Alternatively, or in addition, the sensing circuit 512 applies current to all (or any subset) of the PUF devices 502 to read the binary values associated therewith. For example, the sensing circuit 512 may apply a current of less than or equal to 100 nanoamps.

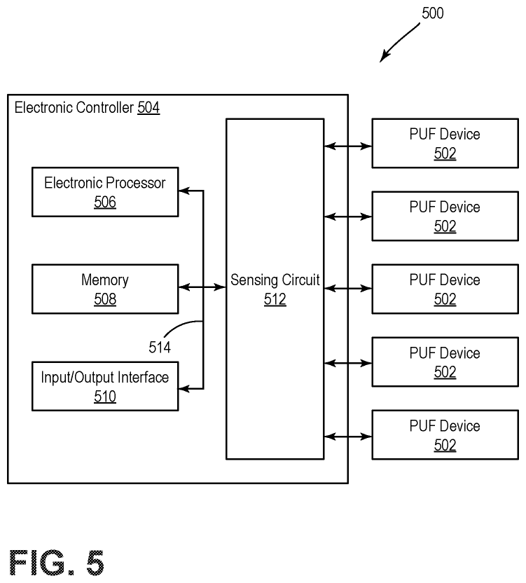

FIG. 6 is a flow diagram of a method 600 for manufacturing a PUF device (e.g., the PUF device 200 described above in relation to FIG. 2). At block 602, a first electrochemically-inactive electrode is deposited. For example, the first electrochemically-inactive electrode is deposited onto a silicon substrate or onto a thick dielectric layer over a silicon substrate. At block 604, a layer of silicon suboxide is deposited onto the first electrochemically-inactive electrode. In some implementations, the layer of silicon suboxide is deposited by physical vapor deposition (“PVD”) (e.g., sputtering, co-sputtering, or reactive sputtering). In other implementations, the layer of silicon suboxide is deposited by chemical vapor deposition (“CVD”) (e.g., low pressure CVD, plasma-enhanced CVD, or remote plasma CVD). At block 606, a second electrochemically-inactive electrode is deposited onto the layer of silicon suboxide. The second electrochemically-inactive electrode is deposited such that the layer of silicon suboxide is positioned directly between the first electrochemically-inactive electrode and the second electrochemically-inactive electrode.

The material of a PUF device, as-deposited, may have a very high resistance which can make the PUF device difficult to read. The resistance of a PUF device can be lowered without actually switching the PUF device by applying an intermediate voltage stress (e.g., around 1.2 volts). The intermediate voltage stress is sufficient to move some of the oxygen vacancies in the material and lower the PUF device's resistance so that more current flows when the PUF device is read below 1 volt. In some implementations, after the second electrochemically-inactive electrode is deposited onto the layer of silicon suboxide, an intermediate voltage stress is applied between the first electrochemically-inactive electrode and the second electrochemically-inactive electrode to lower the resistance of the PUF device. Lowering the resistance of the PUF device makes the PUF device easier to read. For example, an intermediate voltage stress may be applied to an array of PUF devices to lower the average resistance of the array.

### EXAMPLE 1

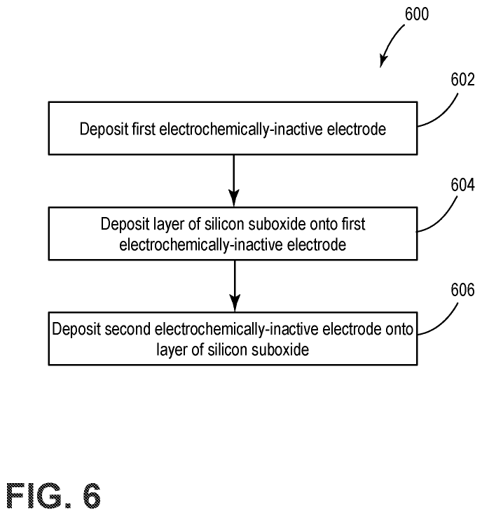

Initial results have been obtained from fabricated two-terminal test structures comprising thin films of SiOₓ deposited using an Oxford PECVD system sandwiched between sputtered inert (W, Ni) electrodes. Two different SiOₓ thicknesses were employed—10 nanometers and 5 nanometers. The 10 nanometer thick oxide devices returned very small currents, in the order of 104 times smaller than the 5 nanometer oxide structures, which scaled with device area. This large difference in current (factor of 104) for a relatively small difference in thickness (factor of 2) is due to the increase in the number of barriers the electrons have to overcome to transit the oxide. The 10 nanometer thick oxides permanently broke down around 3.5 volts. The 5 nanometer thick oxide devices returned around 1 to 100 nanoamps at 1 volt for the small diameter devices (2 to 10 micrometer diameter), with much larger currents for the very large devices. Oxide breakdown occurred around 2.5 volts for these structures. These results are shown in FIG. 7.

As is evident from FIG. 7, with the deposition conditions and thickness used, the 10 micrometer diameter 5 nanometer thick oxide devices provided the desired operating point of 100 nanoamps at 1 volt. The desired operating point can be tuned by altering deposition conditions, oxide thickness, and device area with the following general trends illustrated below in Table #1. It should be noted that the general trends illustrated in Table #1 are simplified for ease of understanding and that, in practice, tuning is a lot more complicated.

TABLE #1

| Parameter | Effect on current |
|---|---|
| Device area | Linear |
| Oxide thickness | Inverse exponential |
| Oxygen to silicon ratio (x) | Inverse power law or inverse exponential |

So, to increase the current in a highly scaled (small area) device, the oxide thickness should be decreased or the oxygen to silicon ratio (i.e., increase silicon content) should be decreased.

### EXAMPLE 2

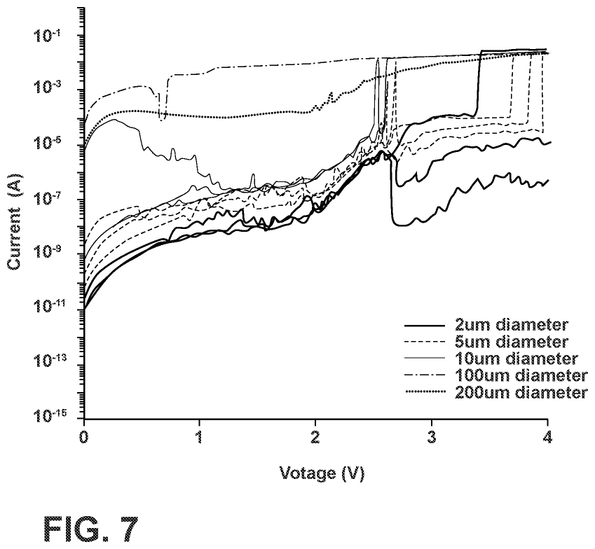

FIG. 8 shows the results from ten consecutive PUF devices in a 32×32 array of PUF devices comprising Ni—SiOₓ—Ni. The SiOₓ material is 5 nanometers thick and deposited by plasma-enhanced chemical vapor deposition. The Ni material is 100 nanometers thick. A voltage of 0.5 volts is applied to the appropriate electrodes and the current flowing through the SiOₓ at the corresponding crossing point is measured. This was performed twenty times for each individual device to assess stability. The results illustrated in FIG. 8 show tight distributions for each individual device but huge differences from device-to-device. This is desirable in a PUF as the current flow in the array can be binned via a current threshold into 0s and 1s and each device can return the same number every time it is read. It is desirable to have large differences between devices so that the measurement and binning process is easy. Selecting a current threshold for this array of 1E-8A, a random number is obtained out of those ten devices. Taking the logic threshold as 10⁻⁸ A and Dev 10 being the most significant bit (“MSB”) and Dev 1 being the least significant bit (“LSB”), this pattern gives the ten digit binary number 1011100011. The read operation would be temperature compensated so that the same number was obtained regardless of the operating temperature of the circuit. For example, higher temperature means more current flow through the SiOₓ for the same voltage and so the threshold should be higher to obtain the same device-to-device distribution of 0s and 1s or the reading voltage should be lowered, again to obtain the same distribution at higher temperature. A constant current could be applied to these devices and the voltage read across them instead (the voltage threshold would go down with increasing temperature in the compensation scheme). It is possible to have a random number that is 1,024 binary digits long if the entire array was used and much larger arrays are also possible. There is a large dynamic range in these devices (over three orders of magnitude) that several thresholds could be added to obtain higher radix numbers—not just 0 and 1 but 0, 1 and 2 by putting in two thresholds, etc.

### EXAMPLE 3

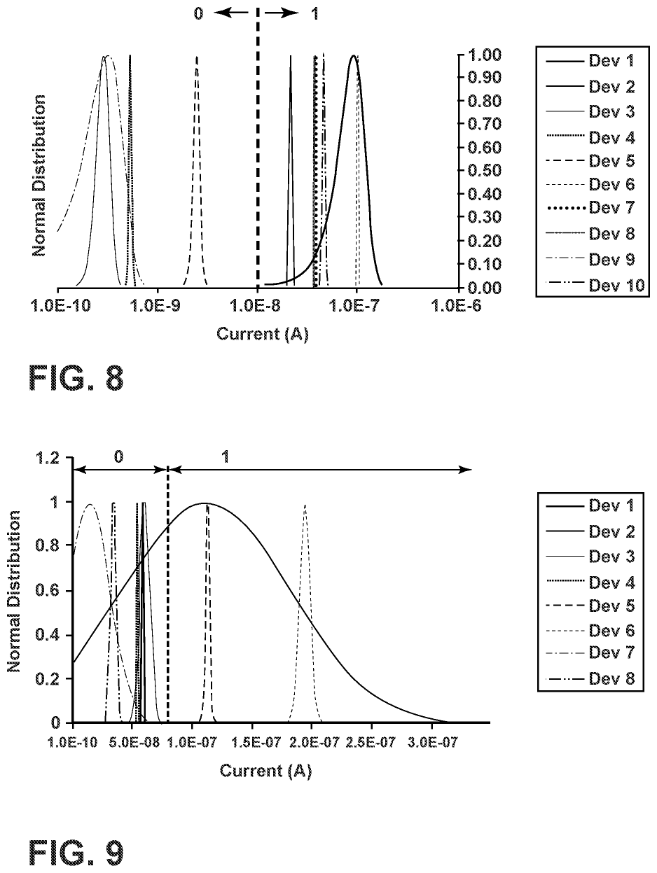

FIG. 9 shows the results for eight consecutive PUF devices (an 8-bit word) in the diagonal of the array, showing the distributions of 100 current measurements at 0.5 volt bias for each of the PUF devices. Table #2 (included below) also show the results. As desired, the standard deviation (“SD”) of the entire set is 5.36×10⁻⁸ amps, which is larger than all but one of the device SDs (device 2, SD=6.93×10⁻⁸ A), and the mean current of the set (the mean of means) is 8.01×10⁻⁸ A. Taking this mean current for all devices as the delincator of logic values 0 and 1, the generated word using the individual device averages, with Device 1 as the MSB and Device 8 as the LSB, is 01001100. The large SD of Device 2 coupled with its mean current of 1.12×10⁻⁷ amps being only 0.5 device SDs away from the 0/1 threshold means that this element could be misread as a 0 around 31% of the time. All the other devices are around four or more device SDs from the threshold and so the error rate is much smaller (0.01% or less).

TABLE #2

| Device # | Current (A) | Binary value | Device SD |
|---|---|---|---|
| 1 | 5.87E−08 | 0 | 6.49E−10 |
| 2 | 1.12E−07 | 1 | 6.93E−08 |
| 3 | 6.03E−08 | 0 | 4.10E−09 |
| 4 | 5.41E−08 | 0 | 4.94E−10 |
| 5 | 1.13E−07 | 1 | 2.02E−09 |
| 6 | 1.94E−07 | 1 | 4.24E−09 |
| 7 | 1.46E−08 | 0 | 1.66E−08 |
| 8 | 3.42E−08 | 0 | 2.22E−09 |
| Population mean | 8.01E−08 | | |
| Population SD | 5.36E−08 | | |

In some implementations that include more PUF devices in the array to generate a random word, PUF devices with high error rates can be ignored and replaced with more stable PUF devices in the array, for example, during a self-test start-up sequence. For example, returning to FIG. 5, the electronic controller 504 may be configured to test the plurality of PUF devices 502 to determine PUF devices 502 with low error rates, select a subset of the plurality of PUF devices 502 from the PUF devices 502 with low error rates, and determine a binary number by reading the binary values associated with the subset of the plurality of PUF devices 502.

### EXAMPLE 4

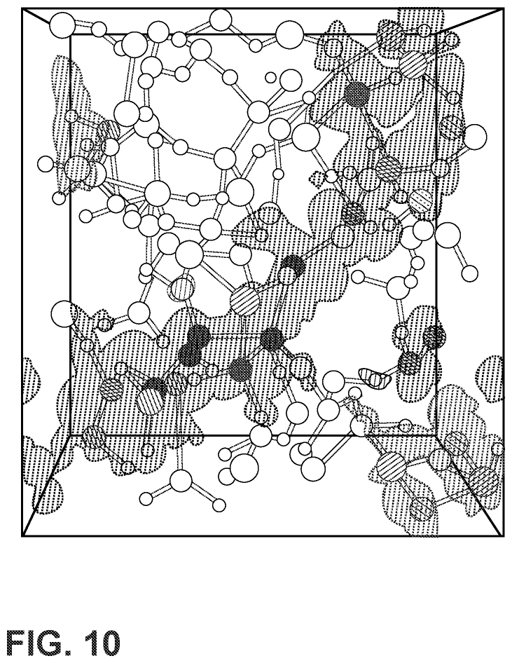

Additional testing uncovered why silicon-rich (or oxygen deficient) materials behave the way they do, i.e., pass much more current than stoichiometric SiO₂ and also why there are such large differences from device-to-device. A DFT simulation of SiOₓ (x=1.3 to 1.7) was run along with “space projected conductivity” techniques to determine where the current paths are in the material. One example of a DFT simulation is shown in FIG. 10 (for x=1.3). The shaded areas are the high conductivity regions, and these tend to be coincident with oxygen vacancies. The results illustrated that while moving from x=1.7 to x=1.3, little “chains” of silicon atoms are seen forming, like nanoscale conducting “filaments” in the oxide. These chains are randomly oriented as they form during the deposition of the oxide from the gas phase—the entropy comes from diffusion processes (which are “naturally random”). It is expected to see large changes in how the current flows in these materials as this will depend on how the filaments line up with each other between the electrodes. The less silicon-rich the material, the less these chains form and the less the variation between PUF devices. Too much silicon is undesirable, otherwise all the conducting regions would join up and again less variation from device-to-device would be observed. Accordingly, it is desirable for x to be around 1.3 (+/−0.1 or so). Thus, in some implementations, the x value of the layer of silicon suboxide is about 1.3.

Additionally, these elements are not only useful for producing random numbers for encryption but also for providing unique IDs for chips. Right now, to give an IC its own unique registration number, an array or large “e-fuse” devices that get programmed (essentially shorted out by applying a high voltage) have to be built before the chip leaves the factory. These arrays give each chip a unique number without the need for large e-fuse devices that take up precious silicon real estate or programming operations that take up valuable testing time.

Various features and advantages of the invention are set forth in the following claims.

1-10. (canceled)

11. A physical unclonable function (“PUF”) device comprising:
a first electrochemically-inactive electrode;
a second electrochemically-inactive electrode; and
a layer of silicon suboxide positioned directly between the first electrochemically-inactive electrode and the second electrochemically-inactive electrode.

12. The PUF device of claim 11, wherein the first electrochemically-inactive electrode including at least one selected from the group consisting of tungsten, nickel, platinum, titanium nitride, tantalum nitride, titanium tungsten, silicon, and polycrystalline silicon.

13. The PUF device of claim 12, wherein the second electrochemically-inactive electrode including at least one selected from the group consisting of tungsten, nickel, platinum, titanium nitride, tantalum nitride, titanium tungsten, silicon, and polycrystalline silicon.

14. The PUF device of claim 11, wherein a thickness of the layer of silicon suboxide is between 4 nanometers and 8 nanometers.

15. The PUF device of claim 11, wherein an x value of the layer of silicon suboxide is between 1.2 and 1.6.

16. The PUF device of claim 11, wherein an x value of the layer of silicon suboxide is about 1.3.

17. A method for manufacturing a physical unclonable function (“PUF”) device, the method comprising:
depositing a first electrochemically-inactive electrode;
depositing a layer of silicon suboxide onto the first electrochemically-inactive electrode; and
depositing a second electrochemically-inactive electrode onto the layer of silicon suboxide such that the layer of silicon suboxide is positioned directly between the first electrochemically-inactive electrode and the second electrochemically-inactive electrode.

18. The method of claim 17, further comprising applying an intermediate voltage stress between the first electrochemically-inactive electrode and the second electrochemically-inactive electrode to lower a resistance of the PUF device.

19. The method of claim 17, wherein a thickness of the layer of silicon suboxide is between 4 nanometers and 8 nanometers.

20. The method of claim 17, wherein an x value of the layer of silicon suboxide is between 1.2 and 1.6.
